(19) United States
(12) Patent Application Publication
(10) Pub. No.: US 2002/0158538 A1
(43) Pub. Date: Oct. 31, 2002

(54) Electrical generator

(76) Inventors: Jeffrey J. Herda, Muskego, WI (US); Mark A. O'Brien, Racine, WI (US)

Correspondence Address: Richard C Litman, Litman Law Offices, PO Box 15035, Arlington, VA, 22215, US

(21) Appl. No.: 09/958,194

(22) PCT Filed: Dec. 18, 2000
(86) PCT No.: PCT/US00/34130

(30) Foreign Application Priority Data
Feb. 15, 2000 (US) 60/182538

(51) Int. Cl. H02K 3/00

(52) U.S. Cl. 310/184

(57) ABSTRACT

A generator (10) for converting mechanical energy to electrical energy is described. The generator (10) includes a housing (12) which rotatably supports a shaft (14). Two sets of coils, a set of primary coils (36), (38), (40), (42), (44), and (46), and a plurality of secondary coils (48), (50), (52), (54), (56), and (58), are fixedly supported by the housing wall (12). The primary and secondary coils are axially spaced apart from one another. Each of them is connected via a diode (64) to a respective one of the secondary coils. A set of permanent magnets is fixed to the shaft (14) and positioned such that the magnets are surrounded by the set of primary coils. A set of armature coils are also supported by the shaft (14) such that the armature coils are surrounded by the set of secondary coils. Current generated in the armature coils is collected using a brush and slip ring arrangement and is conducted out of the generator housing by wires.

### TECHNICAL FIELD

The present invention relates to a device for generating electrical energy.

### BACKGROUND ART

The generation of electrical energy from the mechanical energy supplied by a rotating shaft is well known. Generators using this principle of operation have been manufactured in a variety of sizes for a myriad of different applications ranging from power generation for a large electric utility to recharging an automotive battery. Listed below are examples of electromechanical devices which employ the principle of electromagnetic induction to convert mechanical energy to electrical energy and vice versa.

U.S. Pat. No. 2,952,787, issued to Robert D. Moore on Sep. 13, 1960, shows a fan unit which has contra-rotating fan blades. The fan unit of Moore has an electric motor with contra-rotating field and armature rotors.

U.S. Pat. No. 4,882,513, issued to Wayne A. Flygare et al. on Nov. 21, 1989, shows a dual permanent magnet generator. The device of Flygare et al. includes first and second permanent magnet assemblies which are mounted on a shaft. The permanent magnet assemblies are rotatably mounted for rotation relative to the shaft as well as to each other. The permanent magnet assemblies are connected to the shaft by equal but oppositely pitched helical spline connections.

U.S. Pat. No. 5,124,606, issued to Gottfried Eisenbeis on Jun. 23, 1992, is directed to a servomotor design. The servomotor of Eisenbeis includes two different types of rotors, a main rotor and an auxiliary rotor, both of which are arranged within the field of a common stator.

U.S. Pat. No. 5,177,388, issued to Toshiaki Hotta et al. on Jan. 5, 1993, shows a tandem type alternator for automotive applications. The device of Hotta et al. includes a rotor rotatably supported inside a housing and having a plurality of magnetic poles supported around the rotor. The device of Hotta et al. also includes a plurality of stators arranged on the inside wall of the housing and in tandem in the direction of the axis of rotation of the rotor.

U.S. Pat. No. 5,177,391, issued to Shin Kusase on Jan. 5, 1993, is directed to an alternating current generator. The generator of Kusase includes a rotary shaft which carries permanent magnets and a plurality of magnetic coils. The permanent magnets are axially spaced apart from the magnetic coils. The permanent magnets and the magnetic coils induce current in a stator winding which is helically wound about an axis transverse to the longitudinal axis of the rotary shaft.

U.S. Pat. No. 5,504,382, issued to Michael J. Douglass et al. on Apr. 2, 1996, is directed to an automotive alternator having a pair of axially spaced core sections with a stationary coil located between the core sections. The rotor carries a pair of pole sections formed by permanent magnets. Each of the pole sections registers with a respective one of the core sections.

U.S. Pat. No. 5,675,203, issued to Bernd-Guido Schulze et al. on Oct. 7, 1997, is directed to an electric motor/generator arrangement for varying the speed and direction of rotation of an output shaft. The device of Schulze et al. includes a first rotor fixed to an input shaft and a second rotor fixed to an output shaft. Each of the first and second rotors carries a plurality of permanent magnets of alternately opposite polarity. A short-circuit winding, magnetically coupled to the permanent magnets, is opened or closed in response to signals from sensors located on the rotors.

U.S. Pat. No. 5,708,314, issued to Mingyuen Law on Jan. 13, 1998, is directed to a multi-rotor electric drive device. The device of Law has a plurality of concentric shafts each of which is driven by a separate rotor.

U.S. Pat. No. 5,767,601, issued to Hidekazu Uchiyama on Jun. 16, 1998, shows a permanent magnet electric generator. The generator of Uchiyama has an annular array of permanent magnets surrounding a radially arranged plurality of armature coils.

U.S. Pat. No. 5,793,136, issued to Sabid Redzic on Aug. 11, 1998, is directed to an electric motor/generator device having an inner rotor, a stator, and an outer rotor. The stator is fixed to a housing, the inner rotor is rotatably supported by the stator on the inside thereof. The outer rotor is cooperatively supported by the housing and the exterior of the stator. Shafts, integral with the inner and outer rotors, project from either end of the motor/generator device and allow for the transfer of mechanical power between the inner and outer rotors and other devices.

U.S. Pat. No. 5,793,137, issued to James Andrew Timothy Smith on Aug. 11, 1998, and United Kingdom Patent Application Number 2 264 812 A, by James Andrew Timothy Smith and published on Sep. 8, 1993, are directed to an electrical generator for de-icing aircraft. The generator includes first stationary windings, second stationary windings disposed concentrically about the first stationary windings, a freely rotating annular array of permanent magnetic poles, first rotating windings disposed so as to rotate with the aircraft's propeller, and second rotating windings disposed concentric with the first rotating windings and also disposed so as to rotate with the aircraft's propeller. Because of electromagnetic interactions, the freely rotating annular array of permanent magnetic poles rotates at a different speed relative to the first rotating windings. The rotation of the annular array of magnetic poles causes excitation of the first stationary windings which in turn causes the excitation of the second stationary windings. The excitation of the second stationary windings causes excitation of the second rotating windings. The electricity generated in the first stationary windings, the first rotating windings, and the second rotating windings are used to power heating elements in the wings and propeller blades of the aircraft.

U.S. Pat. No. 5,814,913, issued to Yoshinori Ojima et al. on Sep. 29, 1998, shows a multi-shaft electric motor. The motor of Ojima et al. has a plurality of rotors having permanent magnets and a plurality of sets of armature elements disposed fully circumferentially around the rotors.

U.S. Pat. No. 5,818,144, issued to Ki Bong Kim on Oct. 6, 1998, shows a linear induction motor having inner and outer stators. The stators are made of a plurality of stator pieces to reduce production costs.

U.S. Pat. No. 5,874,797, issued to Joseph F. Pinkerton on Feb. 23, 1999, is directed to a permanent magnet generator with the facility to modulate the frequency of the alternating current it produces. This facility is accomplished by having generator coils that are translationally movable relative to the null position of the magnetic field of the generator.

United Kingdom Patent Specification Number 476,716, by Rudolf Arnold Erren, dated Jan. 13, 1938, is directed to a wind powered generator having two propellers which drive concentric shafts. Each shaft drives an electrical element of an electrical generator. The shafts spin in opposite directions causing the generation of a high frequency alternating current.

United Kingdom Patent Specification Number 1,4023,577, by John Edward Adey, dated Mar. 23, 1966, is directed to a variable speed electric motor assembly. The motor assembly includes a pair of armatures that drive an output shaft via a set of gears. One armature is excited by a stationary field winding while the other armature is excited by a rotating field winding.

Soviet Document Number 1820454 A1, dated Jun. 7, 1993, is directed to an electric motor having a second annular rotor situated within a gap inside the annular magnetic core of the motor's stator.

German Patent Application Number 29 37 754 A1, by. Ernst Geuer, published on Apr. 9, 1981, is directed to an electric motor wherein both the rotor and the stator are capable of rotation and of performing work. Soviet Document Number 1817197. A1, dated May 23, 1993, shows an electric motor with concentric inner and outer cores and with three phase and single phase windings.

Japanese Published Patent Application Number 6-178515, by Toshimi Onodera, dated Jun. 24, 1994, is directed to an electric motor which can provide variable power output without the need for brushes or gears. The motor of Onodera has a permanent magnet rotor and an electromagnet rotor which rotate in opposite directions.

None of the above inventions and patents, taken either singly or in combination, is seen to describe the instant invention as claimed. In particular, none of the documents listed above teach or suggest the unique structure of the electrical generator of the present invention.

### DISCLOSURE OF INVENTION

The present invention is directed to a generator for converting mechanical energy to electrical energy. The generator includes a housing which rotatably supports a shaft. Two sets of coils, a set of primary coils and a set of secondary coils, are fixedly supported by the housing wall. The primary and secondary coils are axially spaced apart from one another. Each of the primary coils is connected via a diode to a respective one of the secondary coils. A set of permanent magnets is fixed to the shaft and positioned such that the magnets are surrounded by the set of primary coils. A set of armature coils are also supported by the shaft such that the armature coils are surrounded by the set of secondary coils Rotation of the shaft induces a current in the primary coils. The current in the primary coils is used to energize the secondary coils which generate a magnetic field around the armature coils. The magnetic field due to the current in the secondary coils induces a current in the armature coils as the armature coils rotate with the generator shaft. The current generated in the armature coils is collected using a brush and slip ring arrangement and is conducted out of the generator housing by wires so that the current may be used to power other electrical devices. Other features of the present invention will become readily apparent upon further review of the following specification and drawings.

### BRIEF DESCRIPTION OF DRAWINGS

FIG. 1 is a cross sectional view of the generator of the present invention taken over a plane containing the longitudinal axis of the rotary shaft of the generator.

FIG. 2 is a cross sectional view of the generator of the present invention taken through the secondary coils of the generator and over a plane transverse to the longitudinal axis of the generator shaft.

FIG. 3 is a cross sectional view of the generator of the present invention taken through the primary coils of the generator and over a plane transverse to the longitudinal axis of the generator shaft.

FIG. 4 is a diagrammatic fragmentary view illustrating the connection of the armature coils to the slip rings of the generator of the present invention.

FIG. 5 is a diagrammatic fragmentary view illustrating the connection of the primary field coils to the secondary field coils in the generator of the present invention.

Similar reference characters denote corresponding features consistently throughout the attached drawings.

### BEST MODE(S) FOR CARRYING OUT THE INVENTION

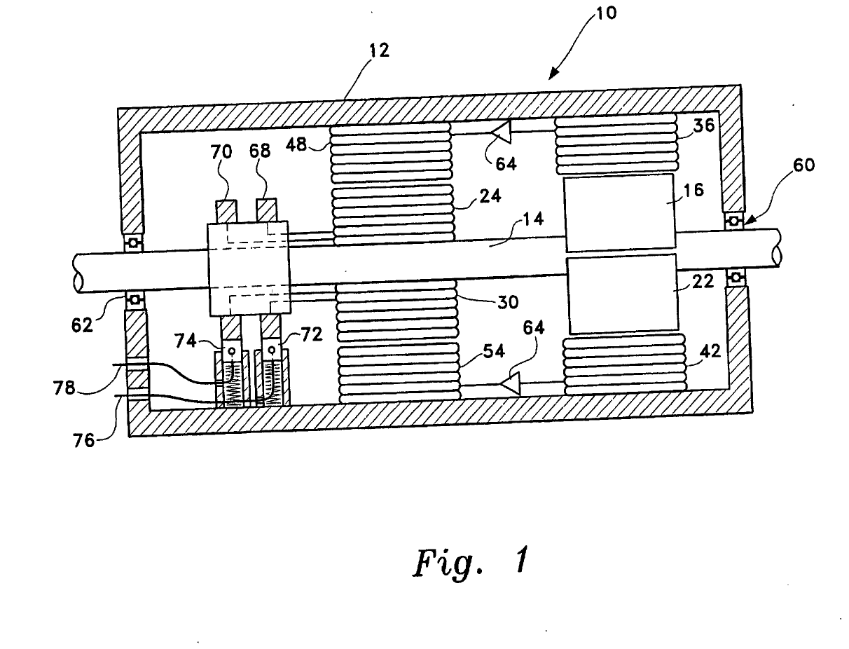

Referring to FIGS. 1-5, the present invention is an electrical generator 10. The generator 10 includes a housing 12, a rotary shaft 14, a plurality of permanent magnets 16, 18, 20, and 22, a plurality of armature coils 24, 26, 28, 30, 32, and 34, a plurality of primary coils 36, 38, 40, 42, 44, and 46, and a plurality of secondary coils 48, 50, 52, 54, 56, and 58. In the illustrated example, the housing 12 is generally cylindrical and has a longitudinal axis which is coincident with the axis of rotation of the shaft 14.

The shaft 14 is rotatably supported at each end of the housing 12 by sets of ball bearings 60 and 62. The shaft 14 should project outward from at least one end of the housing 12 so that the shaft 14 may be engaged by a prime mover such as an internal combustion engine or a steam turbine. The prime mover acts to impart rotation to the shaft 14 and thus supply mechanical energy to the generator 10. The plurality of permanent magnets 16, 18, 20, and 22 are fixedly attached to the shaft 14 and rotate with the shaft 14 as a unit. The magnets 16, 18, 20, and 22 are radially arranged about the shaft 14. The first plurality of armature coils 24, 26, 28, 30, 32, and 34 are also fixed to the shaft 14 and rotate with the shaft 14 as a unit. The first plurality of armature coils 24, 26, 28, 30, 32, and 34 are positioned at a location which is axially spaced from the plurality of permanent magnets 16, 18, 20, and 22 along the length of the shaft 14. The first plurality of armature coils 24, 26, 28, 30, 32, and 34 are arranged radially about the shaft 14.

The 36, 38, 40, 42, 44, and 46 are each fixed to the interior surface of the wall of the housing 12. The 36, 38, 40, 42, 44, and 46 are positioned so as to surround the plurality of permanent magnets 16, 18, 20, and 22. The secondary coils 48, 50, 52, 54, 56, and 58 are each fixed to the interior surface of the wall of the housing 12 at a location axially spaced apart from the 36, 38, 40, 42, 44, and 46. The secondary coils 48, 50, 52, 54, 56, and 58 are positioned to surround the plurality of armature coils 24, 26, 28, 30, 32, and 34. Each of the 36, 38, 40, 42, 44, and 46 has two terminuses. Similarly, each of the secondary coils 48, 50, 52, 54, 56, and 58 has two terminuses. One terminus of each of the 36, 38, 40, 42, 44, and 46 is connected to one of the terminuses of a respective one of the secondary coils 48, 50, 52, 54, 56, and 58 forming a conductive pathway 66. The remaining terminus of each of the 36, 38, 40, 42, 44, and 46 is connected to the remaining terminus of its respective secondary coil 48, 50, 52, 54, 56, or 58 via a diode 64. Thus, the generator 10 includes a plurality of diodes 64, one for each interconnected pair of primary and secondary coils. Each of the 36, 38, 40, 42, 44, and 46 together with its respective diode 64 and its respective secondary coil 48, 50, 52, 54, 56, or 58 forms a complete circuit similar to that shown in FIG. 5.

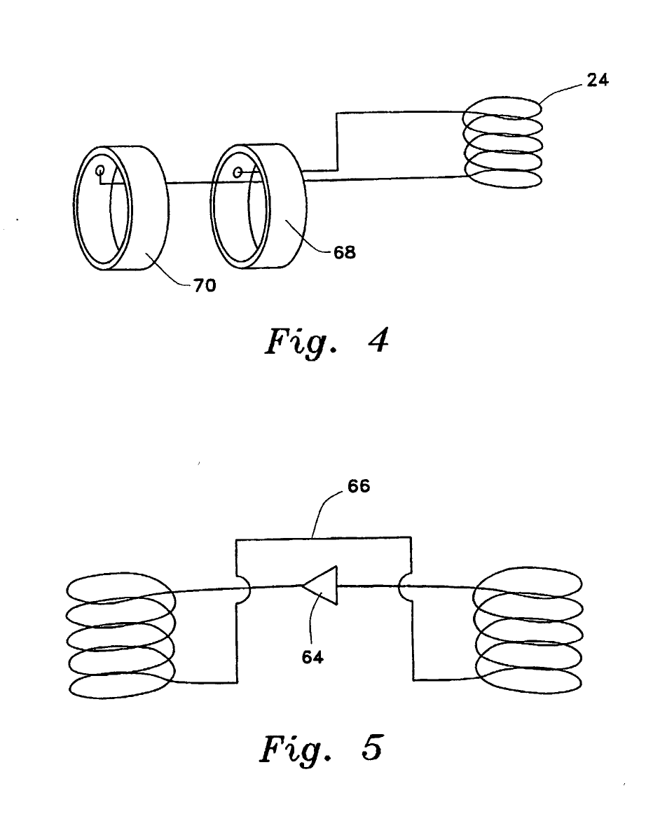

Each of the armature coils 24, 26, 28, 30, 32, and 34 also has a pair of terminuses. The electrical generator 10 also includes a pair of slip rings 68 and 70. The slip rings 68 and 70 are fixed to the shaft 14 and rotate with the shaft 14 and with the armature coils 24, 26, 28, 30, 32, and 34. Each terminus of each of the armature coils 24, 26, 28, 30, 32, and 34 is connected to a respective one of the slip rings 68 and 70 in a manner similar to the example illustrated in FIG. 4. A pair of brushes 72 and 74 are in contact with the slip rings 68 and 70, respectively. The brushes 72 and 74 are supported by the housing 12 and are spring biased into continuous contact with the slip rings 68 and 70 even as the slip rings 68 and 70 rotate with the shaft 14 and move rotationally relative to the brushes 72 and 74. The brushes 72 and 74 collect the current generated in the armature coils 24, 26, 28, 30, 32, and 34 as the shaft 14 rotates. A pair of conductors 76 and 78 are connected to the brushes 72 and 74, respectively. The conductors 76 and 78 convey the electrical current collected by the brushes 72 and 74 to the exterior of the housing 12, so that the current generated in the armature coils 24, 26, 28, 30, 32, and 34 may be supplied to a power grid or used to power other electrical devices.

Because the permanent magnets 16, 18, 20, and 22 rotate with the shaft 14, the permanent magnets provide a time varying magnetic field flux through the 36, 38, 40, 42, 44, and 46. This time varying magnetic flux generates current in the 36, 38, 40, 42, 44, and 46. Thus, the 36, 38, 40, 42, 44, and 46 are in essence a second plurality of armature coils, the armature coils 24, 26, 28, 30, 32, and 34 being the first plurality of armature coils. Each of the 36, 38, 40, 42, 44, and 46 being connected to a respective one of the secondary coils 48, 50, 52, 54, 56, and 58, the current generated in the will flow through the secondary coils 48, 50, 52, 54, 56, and 58. Current flow through the secondary coils 48, 50, 52, 54, 56, and 58 generates a magnetic field about the armature coils 24, 26, 28, 30, 32, and 34. Therefore, the secondary coils 48, 50, 52, 54, 56, and 58 are in essence a plurality of field coils for the armature coils 24, 26, 28, 30, 32, and 34. As the armature coils 24, 26, 28, 30, 32, and 34 rotate with the shaft 14, the armature coils 24, 26, 28, 30, 32, and 34 move relative to the magnetic field generated by the secondary coils 48, 50, 52, 54, 56, and 58 which leads to a time varying magnetic field flux through the armature coils 24, 26, 28, 30, 32, and 34. The time varying magnetic field flux through the armature coils 24, 26, 28, 30, 32, and 34 induces electrical currents in the armature coils 24, 26, 28, 30, 32, and 34 which are then collected by the brushes 72 and 74. Thus, the rotation of the shaft 14 leads to the generation of electrical current by the generator 10.

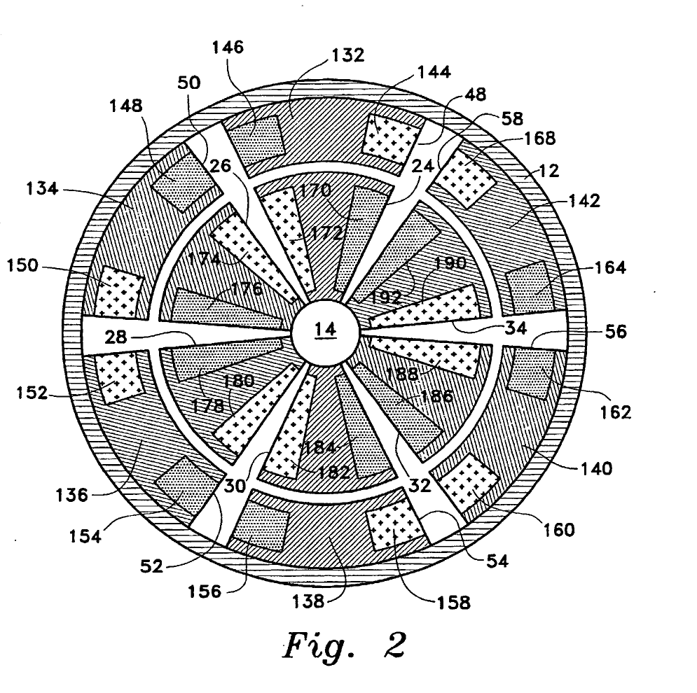

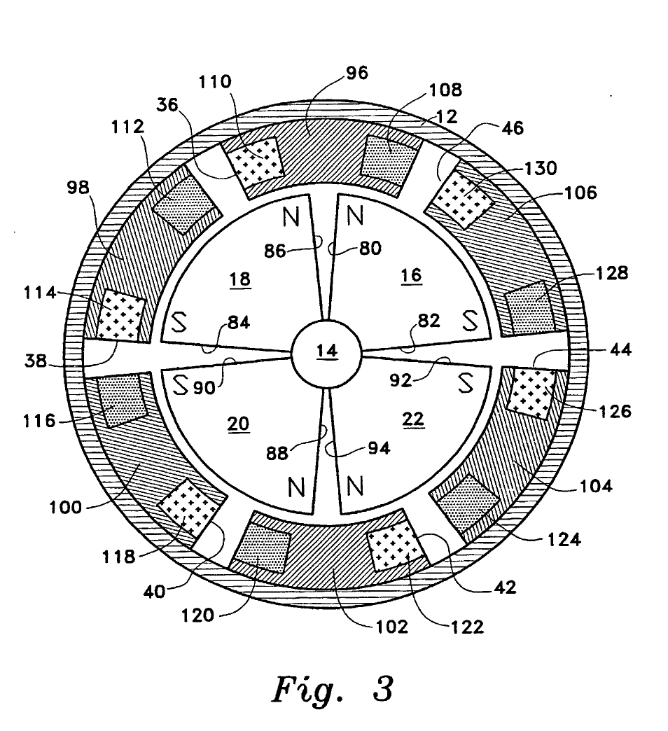

Referring to FIGS. 2 and 3, the operation of the generator 10 will be explained in greater detail so that certain novel aspects of the present invention may become more readily apparent. For the present discussion, assume that the shaft 14 is being rotated in the counter clockwise direction in FIGS. 2 and 3. Each of the magnets 16, 18, 20, and 22 has a leading edge which sweeps past a given primary coil 36, 38, 40, 42, 44, or 46 ahead of the magnet's trailing edge, as the shaft 14 rotates in the counterclockwise direction. In the illustrated embodiment, the north pole of the magnet 16 is adjacent the leading edge 80 of the magnet 16, while the south pole of the magnet 16 is adjacent the trailing edge 82 of the magnet 16. The north pole of the magnet 18 is adjacent the trailing edge 86 of the magnet 18, while the south pole of the magnet 18 is adjacent the leading edge 84 of the magnet 18. The north pole of the magnet 20 is adjacent the leading edge 88 of the magnet 20, while the south pole of the magnet 20 is adjacent the trailing edge 90 of the magnet 20. The north pole of the magnet 22 is adjacent the trailing edge 94 of the magnet 22, while the south pole of the magnet 22 is adjacent the leading edge 92 of the magnet 22.

Each of the 36, 38, 40, 42, 44, and 46 is formed by a plurality of helical windings around a core 96, 98, 100, 102, 104, or 106, usually made of soft iron. Each of the 36, 38, 40, 42, 44, and 46 is wound about an axis which is transverse to the longitudinal axis of the shaft 14 and is coincident with a radius of the housing 12. As a pair of adjacent north poles approaches a primary coil 36, 38, 40, 42, 44, or 46 a voltage will be induced in the primary coil which opposes the motion of the pair of adjacent north poles. As an example, as the two north poles of the magnets 16 and 18 approach the primary coil 36, a voltage will be induced in the primary coil 36 which tends to form a north pole at the end of the primary coil 36 distal from the wall of the housing 12, because a north pole at this location would tend to repel the approaching north poles of the magnets 16 and 18 and would thus oppose the motion of the north poles of the magnets 16 and 18 toward the primary coil 36. Simultaneous with the approach of the north poles of the magnets 16 and 18, the south poles of the magnets 18 and 20 recede from the primary coil 36. A north pole at the end of the primary coil 36 distal from the wall of the housing 12 also opposes the motion of the south poles of the magnets 18 and 20 away from the primary coil 36. Thus, the movement of the north and south poles of the magnets 16, 18, and 20 tend to induce a north pole at the end of the primary coil 36 distal from the wall of the housing 12.

The 36, 38, 40, 42, 44, and 46 can also be thought of having a leading side which is reached by a rotating magnet 16, 18, 20, or 22 ahead of the trailing side of the primary coil 36, 38, 40, 42, 44, or 46. To achieve a north pole at the end of the primary coil 36 distal from the wall of the housing 12, the current in the leading side 108 of the primary. coil 36 must come out of the plane of the page of FIG. 3 as indicated by the dotted shading while the current in the trailing side 110 of the primary coil 36 must go into the plane of the page of FIG. 3 as indicated by the shading in the form of a pattern of crosses.

Each of the leading sides 108, 112, 116, 120, 124, and 128 of the 36, 38, 40, 42, 44, and 46 is connected to the positive terminal of the respective diode 64. Thus, each diode 64 is, forward biased when the magnets 16, 18, 20, and 22 tend to induce a north pole in the radially inward end of its respective primary coil 36, 38, 40, 42, 44, or 46, and each diode 64 is reverse biased when the magnets 16, 18, 20, and 22 tend to induce a south pole in the radially inward end of its respective primary coil 36, 38, 40, 42, 44, or 46. Therefore, current flows from each primary coil 36, 38, 40, 42, 44, or 46 to its respective secondary coil 48, 50, 52, 54, 56, or 58 only when the magnets 16, 18, 20, and 22 tend to induce a north pole in the radially inward end of the particular primary coil 36, 38, 40, 42, 44, or 46.

Each of the secondary coils 48, 50, 52, 54, 56, and 58 is formed by a plurality of helical windings around a core 132, 134, 136, 138, 140, or 142, usually made of soft iron. Each of the secondary coils 48, 50, 52, 54, 56, and 58 is wound about an axis which is transverse to the longitudinal axis of the shaft 14 and is coincident with a radius of the housing 12. The secondary coils 48, 50, 52, 54, 56, and 58 also have a leading side which is reached by a rotating armature coil 24, 26, 28, 30, 32, or 34 ahead of the trailing side of the secondary coil 48, 50, 52, 54, 56, or 58.

The leading side 108 of the primary coil 36 is connected via a diode 64 to the trailing side 146 of the secondary coil 48, and the trailing side 110 of the primary coil 36 is connected to the leading side 144 of the secondary coil 48. The leading side 112 of the primary coil 38 is connected via a diode 64 to the leading side 148 of the secondary coil 50, and the trailing side 114 of the primary coil 38 is connected to the trailing side 150 of the secondary coil 50. The leading side 116 of the primary coil 40 is connected via a diode 64 to the trailing side 154 of the secondary coil 52, and the trailing side 118 of the primary coil 40 is connected to the leading side 152 of the secondary coil 52. The leading side 120 of the primary coil 42 is connected via a diode 64 to the leading side 156 of the secondary coil 54, and the trailing side 122 of the primary coil 42 is connected to the trailing side 158 of the secondary coil 54. The leading side 124 of the primary coil 44 is connected via a diode 64 to the trailing side 162 of the secondary coil 56, and the trailing side 126 of the primary coil 44 is connected to the leading side 160 of the secondary coil 56. The leading side 128 of the primary coil 46 is connected via a diode 64 to the leading side 164 of the secondary coil 58, and the trailing side 130 of the primary coil 46 is connected to the trailing side 168 of the secondary coil 58. The negative terminal of each diode 64 is connected to the respective secondary coil 48, 50, 52, 54, 56, or 58. Thus, the secondary coil 48 will be a south pole, the secondary coil 50 will be a north pole, the secondary coil 52 will be a south pole, the secondary coil 54 will be a north pole, the secondary coil 56 will be a south pole, and the secondary coil 58 will be a north pole. In other words, each adjacent pair of secondary coils have opposite polarity. As used herein, the polarity of a secondary coil refers to the magnetic polarity present at the radially inward end of the secondary coil.

Therefore, as the armature coils 24, 26, 28, 30, 32, and 34 rotate relative to the secondary coils 48, 50, 52, 54, 56, or 58, the time rate of change of magnetic flux through the armature coils is not only determined by the relative rotation between the armature coils 24, 26, 28, 30, 32, and 34 and the secondary coils 48, 50, 52, 54, 56, and 58, but is also enhanced by the time varying current supplied to the secondary coils 48, 50, 52, 54, 56, and 58. The time varying current supplied to the secondary coils 48, 50, 52, 54, 56, and 58 mimics the effect of having the secondary coils rotate in a direction counter to the direction of the rotation of the shaft 14. Thus, an alternating current of a given frequency and voltage can be achieved at a lower shaft RPM by the generator 10, as compared to a conventional generator. This lower shaft RPM leads to reduced wear and tear of the shaft bearings, the slip rings, and the brushes. Also, the lower shaft RPM results in reduced frictional losses within the generator 10, thus resulting in a more efficient generator.

Each of the armature coils 24, 26, 28, 30, 32, and 34 is formed by a plurality of helical windings around a core, usually made of soft iron. Each of the armature coils 24, 26, 28, 30, 32, and 34 is wound about an axis which is transverse to the longitudinal axis of the shaft 14 and is coincident with a radius of the housing 12. Each of the armature coils 24, 26, 28, 30, 32, and 34 also has a leading side 172, 176, 180, 184, 188, or 192, respectively, which reaches a given secondary coil ahead of the trailing side 170, 174, 178, 182, 186, or 190 of each armature coil. Each adjacent pair of armature coils have opposite polarity in so far as the manner in which the armature coils 24, 26, 28, 30, 32, and 34 are connected to the slip rings 68 and 70. For example, if the leading side 172 of the armature coil 24 is connected to the slip ring 70 and the trailing side 170 of the armature coil 24 is connected to the slip ring 68, then the leading side 176 of the armature coil 26 is connected to the slip ring 68 and the trailing side 174 of the armature coil 26 is connected to the slip ring 70. This arrangement in necessary to minimize the destructive interference between the currents in adjacent pairs of armature coils, because the voltages induced in adjacent pairs of armature coils are out of phase relative to one another.

### Conversion from AC to DC Generator

As diagrammatically illustrated in FIG. 2, the only modifications needed to convert the alternating current (AC) generator to a direct current (DC) generator are to reverse the coil sets around cores 134, 138 and 142 including corresponding windings for the armature coils 26, 30 and 34, respectively. All other components will remain unchanged. In more detail, the direction of the coil windings 148, 156, and 164 as directionally indicated by dots or arrow tips (indicating current flow out of the page) and the direction of coil windings 150, 158 and 168 as directionally indicated by plus signs or arrow tail ends (+) (indicating current flow into the page) will be reversed, respectively for each coil set 134, 138 and 142. That is the direction of the coil windings on 148, 156 and 164 on the secondary coil sets 50, 54 and 58, respectively should be change to reflect arrow tail ends (+) to indicate current flow into the paper. This modification will produce current flow through coil windings 150, 158 and 168 as current flow out of the paper indicated as arrow tips. In a similar way, the direction of the windings 174, 176 182, 184 and 190, 192 of respective primary coil sets 26, 30 and 34 changed in reverse such that the coil windings 176, 184 and 192 on the armature should be indicated as arrow ends (+) to indicate current flow into the paper while coil windings 174, 182 and 190 indicated as arrow tips or dots to indicate current flow out of the paper respectively. This modification to both respective primary and secondary coil sets will produce a DC current to be generated. Accordingly, the generator uses permanent magnets to energize the field coils which induce electrical current in the armature coils. The generator provides a magnetic field which is used to induce electrical current in the armature coils which effectively produces rotation in a direction opposite the direction of rotation of the armature coils, without actually physically rotating the field coils. In the AC supply, the electrical generator produces a higher frequency and voltage alternating current at a given shaft RPM, as compared to conventional generators. The electrical generator provides improved elements and arrangements thereof in an apparatus for the purposes described which is inexpensive, dependable and fully effective in accomplishing its intended purposes.

However, it is to be understood that the present invention is not limited to the sole embodiment described above, but encompasses any and all embodiments within the scope of the following claims.

We claim:

1. An electrical generator comprising:
a housing;
a shaft rotatably supported by said housing;
a plurality of permanent magnets attached to said shaft and radially arranged about said shaft;
a first plurality of armature coils attached to said shaft at a location axially spaced from said plurality of permanent magnets, said first plurality of armature coils being arranged radially about said shaft;
a second plurality of armature coils supported by said housing and positioned to surround said plurality of permanent magnets;
a plurality of field coils supported by said housing and positioned to surround said first plurality of armature coils; and
a plurality of diodes, each of said second plurality of armature coils being connected to a respective one of said plurality of field coils at least in part via a respective one of said plurality of diodes.

2. The electrical generator according to claim 1, wherein each of said first plurality of armature coils has a pair of terminuses, the electrical generator further comprising:
first and second slip rings attached to said shaft, each of said first plurality of armature coils having one of said pair of terminuses thereof connected to said first slip ring and another of said pair of terminuses thereof connected to said second slip ring;
a first brush in contact with said first slip ring; and
a second brush in contact with said second slip ring, whereby said first and second brushes collect the current generated in said first plurality of armature coils as said shaft rotates.

3. An electrical generator comprising:
a housing;
a shaft rotatably supported by said housing;
a plurality of permanent magnets attached to said shaft and radially arranged about said shaft;
a first plurality of armature coils attached to said shaft at a location axially spaced from said plurality of permanent magnets, said first plurality of armature coils being arranged radially about said shaft;
a second plurality of armature coils supported by said housing and positioned to surround said plurality of permanent magnets;
a plurality of field coils supported by said housing and positioned to surround said first plurality of armature coils;
a plurality of diodes, each of said second plurality of armature coils being connected to a respective one of said plurality of field coils at least in part via a respective one of said plurality of diodes, and
first and second slip rings attached to said shaft, each of said first plurality of armature coils having one of said pair of terminuses thereof connected to said first slip ring and another of said pair of terminuses thereof connected to said second slip ring;
a first brush in contact with said first slip ring; and
a second brush in contact with said second slip ring, whereby said first and second brushes collect the current generated in said first plurality of armature coils as said shaft rotates.
